(19) United States
(12) Patent Application Publication
(10) Pub. No.: US 2023/0399986 A1
(43) Pub. Date: Dec. 14, 2023

(54) MONITORING SYSTEMS FOR HYDROGEN FUELED AIRCRAFT

(71) Applicant: General Electric Company, Schenectady, NY (US)

(72) Inventor: Constantinos Minas, Niskayuna, NY (US)

(21) Appl. No.: 17/836,681

(22) Filed: Jun. 9, 2022

(51) Int. Cl. F02C 9/46; F02C 7/232; F02C 9/40

(52) U.S. Cl. CPC F02C 9/46; F02C 7/232; F02C 9/40; F05D 2220/323; F05D 2260/60; F05D 2260/80; F05D 2270/306; F05D 2270/802

(57) ABSTRACT

Methods and apparatus are for monitoring systems for hydrogen fueled aircraft. An example fuel distribution system distribution system includes a first hydrogen fuel tank, a first sensor associated with the first hydrogen fuel tank, a second sensor associated with the combustor, and a controller to determine a first rate of change in a first amount of hydrogen in the first hydrogen fuel tank based on a first input from the first sensor, determine a flow rate of hydrogen into the combustor based on a second input from the second sensor, determine an average mass loss rate based on the first rate of change and the flow rate and in response to determining the average mass loss rate satisfies a first threshold, determine a leak is present in the fuel distribution system.

### FIELD OF THE DISCLOSURE

This disclosure relates generally to fuel distribution systems, and, more particularly, to hydrogen distribution systems.

### BACKGROUND

Aircraft fuel distribution systems support fuel storage and fuel distribution to an engine. In some examples, a fuel system can include a single, gravity feed fuel tank with an associated fuel line connecting the tank to the aircraft engine. In some examples, multiple fuel tanks can be present as part of the fuel distribution system. The one or more tank(s) can be located in a wing, a fuselage, and/or a tail of the aircraft. The tank(s) can be connected to internal fuel pump(s) with associated valve(s) and/or plumbing to permit feeding of the engine, refueling, defueling, individual tank isolation, and/or overall optimization of an aircraft's center of gravity.

### BRIEF DESCRIPTION OF THE DRAWINGS

A full and enabling disclosure of the preferred embodiments, including the best mode thereof, directed to one of ordinary skill in the art, is set forth in the specification, which makes reference to the appended Figures, in which:

FIG. 1 is a simplified illustration including a hydrogen fuel distribution system in which the teachings of this disclosure can be implemented.

FIG. 2 is a schematic illustration of a first example fuel distribution system implemented in accordance with the teachings of this disclosure.

FIG. 3 is a schematic illustration of a second example fuel distribution system implemented in accordance with the teachings of this disclosure.

FIG. 4 is a block diagram of an example implementation of the controller of FIG. 1.

FIGS. 5A and 5B are diagrams depicting the average mass loss of the fuel distribution systems of FIGS. 2 and/or 3.

FIG. 6 is a flowchart representative of example machine readable instructions and/or example operations that may be executed by example processor circuitry to implement the controller of FIGS. 1 and 4.

FIG. 7 is a block diagram of an example processing platform including processor circuitry structured to execute the example machine readable instructions of FIG. 6 to implement the controller circuitry of FIG. 4.

The figures are not to scale. Instead, the thickness of the layers or regions may be enlarged in the drawings. In general, the same reference numbers will be used throughout the drawing(s) and accompanying written description to refer to the same or like parts. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. Connection references (e.g., attached, coupled, connected, joined, detached, decoupled, disconnected, separated, etc.) are to be construed broadly and may include intermediate members between a collection of elements and relative movement between elements unless otherwise indicated. As used herein, the term “decouplable” refers to the capability of two parts to be attached, connected, and/or otherwise joined and then be detached, disconnected, and/or otherwise non-destructively separated from each other (e.g., by removing one or more fasteners, removing a connecting part, etc.). As such, connection/disconnection references do not necessarily infer that two elements are directly connected and in fixed relation to each other. Stating that any part is in “contact” with another part means that there is no intermediate part between the two parts.

Descriptors “first,” “second,” “third,” etc., are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Hydrogen-based systems can be used to power vehicles such as aircraft and/or turbines. For aircraft-based usage, hydrogen can be stored as pressurized gas or in liquid form. Liquid hydrogen (LH2) storage tanks are lighter than tanks filled with gaseous hydrogen (GH2) due to the reduced tank volume needed to store liquid hydrogen versus gaseous hydrogen. Liquid hydrogen requires temperature regulation to minimize heat transfer and allow the liquid hydrogen to remain cold, thereby avoiding the vaporization of the hydrogen over time. Aircraft fuel distribution systems using cryogenic fuel tanks (e.g., fuels requiring storage at extremely low temperatures to maintain them in a liquid state) generally include a flow control valve, a volumetric flowmeter, a cryogenic valve, a flexible vacuum-jacketed flowline, and an onboard cryogenic fuel tank.

In addition to using liquid hydrogen, hydrogen-based fuel distribution systems can deliver gaseous hydrogen at required pressure(s) and/or flow rate(s) to a combustor to meet the transient performance requirements needed to assure that the engine meets both transient and cruise condition requirements. However, the fuel flow rate for an aircraft varies significantly during the flight mission. For example, the highest fuel flow rate is required during takeoff, which is approximately four times the fuel flow rate at cruise altitude.

Methods and apparatus disclosed herein incorporate liquid hydrogen (LH2), cryo-compressed hydrogen (CCH2) and/or gaseous hydrogen (GH2) into fuel distribution systems (e.g., a LH2 fuel distribution system, a GH2 fuel distribution system, a CCH2 fuel distribution system, etc.) of a gas turbine engine. Examples disclosed herein include a system that continuously monitors the health of the hydrogen tank(s) and the fuel distribution system(s) of a gas turbine associated with an aircraft. In some examples disclosed herein, pressure, temperature, and/or liquid level sensors determine the mass flow rate of the hydrogen in and/or out of the tanks as a function of time and a flowmeter determines the outflow of hydrogen into the combustor of the gas turbine engine. In some examples disclosed herein, the system can also determine the outflow of hydrogen vented via a vent valve. Examples disclosed herein compare the flow of hydrogen from the tanks and the outflowing hydrogen to determine a mass loss rate from the fuel distribution system. Examples disclosed herein can also utilized to analyze the health of a fuel distribution system including other hydrogen fuel sources (e.g., one or more cryo-compressed hydrogen tank(s), etc.).

In some examples disclosed herein, the average mass loss rate over a period of time can be compared to a plurality of thresholds. In some examples disclosed herein, if the mass loss rate is greater than zero over the period, the health monitoring system can conclude a leak is present in the fuel distribution system. In some such examples disclosed herein, the health monitoring system can identify the portion of the system including the leak and isolate the section to prevent additional hydrogen leaking. In some examples disclosed herein, if the mass loss rate is negative over the period (e.g., indicating a gain of mass, etc.), the health monitoring system can conclude that the sensors of the system need to be recalibrated. In some examples disclosed herein, if the mass loss rate is zero, the health monitoring system can conclude there are no health issues with the engines. In some examples disclosed herein, the system can be used to calibrate the flowmeter of the combustor.

For the figures disclosed herein, identical numerals indicate the same elements throughout the figures.

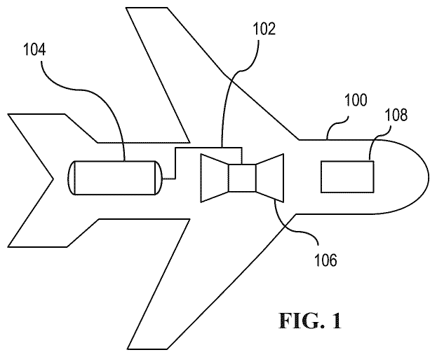

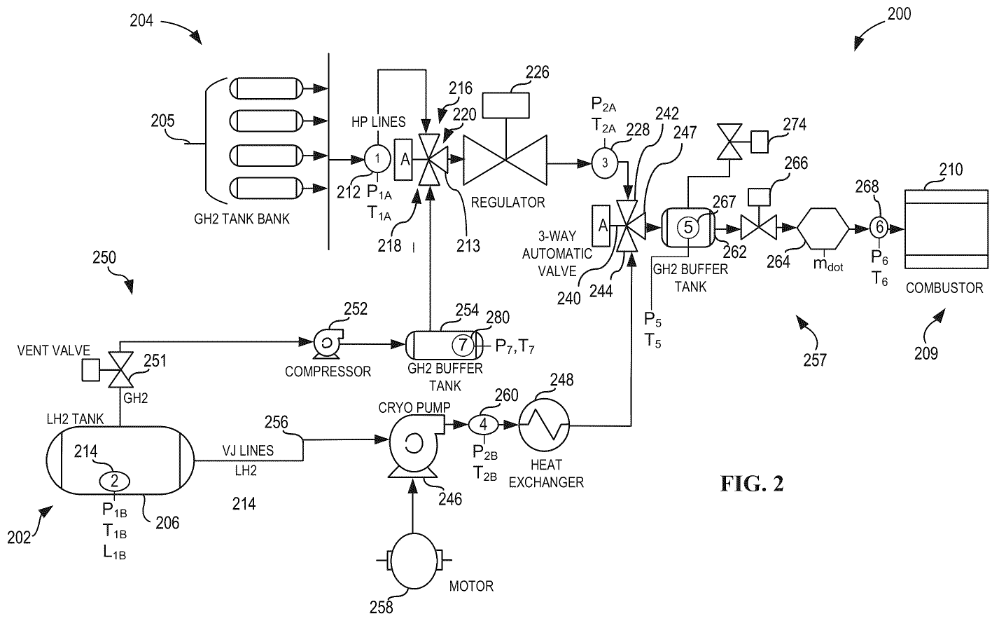

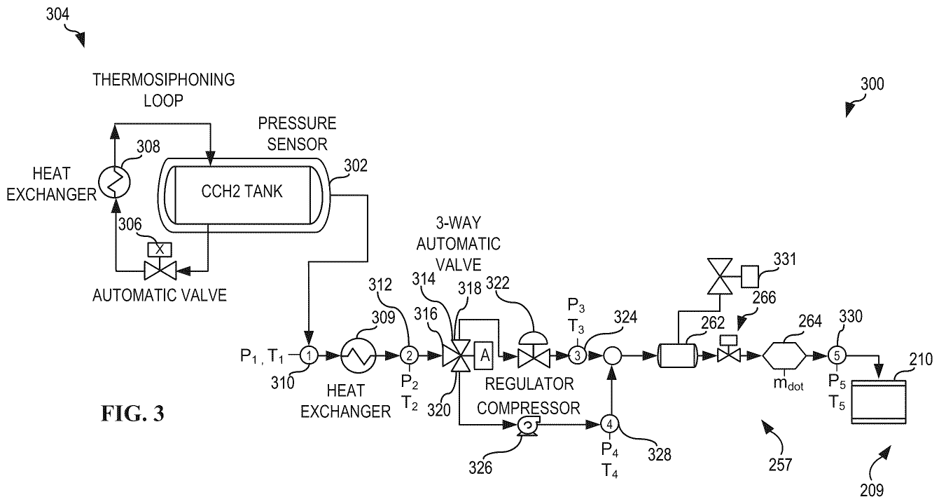

FIG. 1 is an example illustration of an aircraft 100 including an example fuel distribution system 102. The fuel distribution system 102 includes an example tank 104 of hydrogen, which provides fuel to an example gas turbine engine 106. Example implementations of the fuel distribution system 102 are described below in conjunction with FIGS. 2 and 3. The example tank 104 can contain hydrogen in various states, including liquid, gaseous, and cryo-compressed states. The example tank 104 can be stored in any suitable location on the aircraft (e.g., in the wings, in the fuselage, in an external tank, etc.). In other examples, the tank 104 can include multiple tanks (herein referred to as a tank bank, etc.).

Although the aircraft 100 shown in FIG. 1 is an airplane, the embodiments described herein may also be applicable to other fixed-wing aircraft, including unmanned aerial vehicles (UAV). The fuel distribution system 102 can be used to provide hydrogen fuel that will be combusted in an example gas turbine engine 106 of the aircraft 100. In the illustrated example of FIG. 1, the aircraft includes a single gas turbine engine (e.g., the gas turbine engine 106, etc.). In some examples, the aircraft 100 can include multiple gas turbine engines.

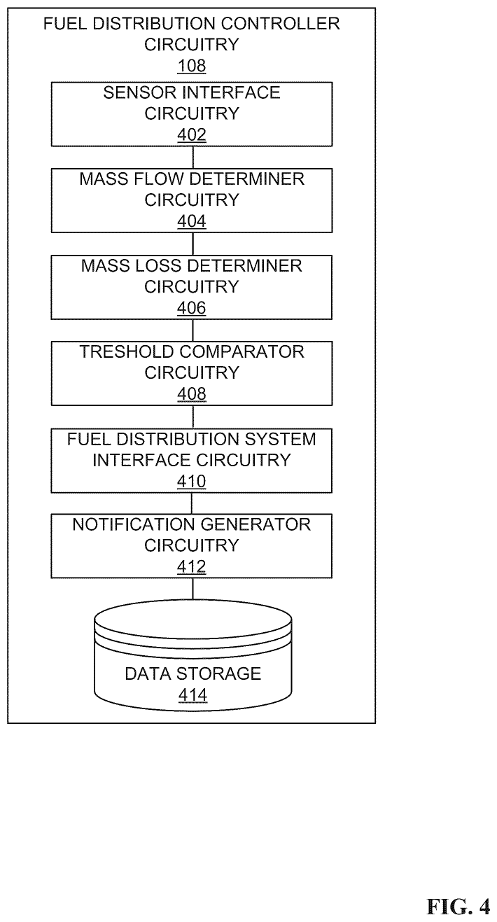

In FIG. 1, the fuel distribution system 102 is controlled and monitored by example fuel distribution controller circuitry 108. For example, the fuel distribution controller circuitry 108 can regulate the flow of hydrogen through the fuel distribution system 102 via one or more control mechanisms (e.g., valves, etc.) to meet a throttle demand from the aircraft 100. The fuel distribution controller circuitry 108 monitors the health of the fuel distribution system 102. For example, the fuel distribution controller circuitry 108 can determine an outflow of hydrogen from the tank 104 and inflow of hydrogen into the gas turbine engine 106. The fuel distribution controller circuitry 108 can compare the inflow of hydrogen into the fuel distribution system 102 to the outflow of hydrogen out of the fuel distribution system 102 to determine a mass loss rate of the fuel distribution system 102. In some examples, the fuel distribution controller circuitry 108 can compare the determined mass loss rate to one or more thresholds to determine the health of the fuel distribution system 102. In some examples, the fuel distribution controller circuitry 108 can determine that a leak is present in the fuel distribution system 102 and/or the sensors of the fuel distribution system need to be recalibrated. An example implementation of the fuel distribution controller circuitry 108 is described below in conjunction with FIG. 4.

The embodiments of the fuel tank(s) described herein may also be applicable to other applications where hydrogen is used as a fuel in the aircraft 100. The embodiments described herein also may be applicable to engine(s) other than gas turbine engines. While the gas turbine engine 106 is an example of a power generator for powering the aircraft 100 using hydrogen as a fuel, hydrogen may also be used as a fuel for other power generators. For example, a power generator may be a fuel cell (e.g., hydrogen fuel cell, etc.) where the hydrogen is provided to the fuel cell to generate electricity by reacting with air.

FIG. 2 illustrates an example first fuel distribution system 200 using an example liquid hydrogen delivery assembly 202 and an example gaseous hydrogen delivery assembly 204, which include an example GH2 tank bank 205 and an example LH2 tank 206, respectively. In the example of FIG. 2, the GH2 tank bank 205 and an example LH2 tank 206 fuel an example engine 209 of an aeronautical vehicle, where the engine can be an aeronautical gas turbine engine (e.g., the gas turbine engine 106 of FIG. 1, etc.). In other examples, the first fuel distribution system 200 can be any other suitable land or aeronautical vehicle and the engine may be any other suitable engine mounted to or within the vehicle in any suitable manner. In the illustrated example of FIG. 2, the first fuel distribution system 200 delivers fuel to an example combustor 210.

The first fuel distribution system 200 of FIG. 2 includes the GH2 tank bank 205 to hold a first portion of hydrogen fuel in a gaseous phase, and/or the LH2 tank 206 to hold a second portion of hydrogen fuel in a liquid phase. In some examples, the GH2 tank bank 205 can be used to provide gaseous hydrogen during takeoff and climbing, while the LH2 tank 206 can be switched to during a cruising phase of flight. For example, fuel consumption needs can vary based on a particular phase of the flight (e.g., taxing, takeoff, cruising, etc.). A relatively low hydrogen fuel flow is required during the taxi operation, while the takeoff phase requires the highest consumption of fuel (e.g., about 100% of a maximum hydrogen fuel flow for a given flight path). Meanwhile, the climb phase shows reduced fuel consumption (e.g., between about 50% and about 90% of the maximum hydrogen fuel flow). Cruising is the longest operation during a given flight, with much lower fuel consumption (e.g., between about 25% and about 40% of the maximum hydrogen fuel flow). During approach and landing operations/flight phases, fuel flow is the lowest (e.g., less than about 20%, such as less than about 15% of the maximum hydrogen fuel flow). Using the liquid hydrogen delivery assembly 202 and an example gaseous hydrogen delivery assembly 204 shown in FIG. 2 permits varying arrangement(s) of fuel distribution based on a given operation being performed by the aircraft (e.g., taxing, takeoff, cruising, etc.) to match the necessary fuel flows.

The flows from the GH2 tank bank 205 and the LH2 tank 206 are tracked by one or more sensor(s), which sense various operability parameters of the first fuel distribution system 200 of FIG. 2. In the illustrated example of FIG. 2, an example first sensor 212 is configured to sense flow data (e.g., pressure (P), temperature (T), etc.) relating to the GH2 tank bank 205 (depicted as P₁, T₁ in FIG. 2) and an example second sensor 214 configured to sense flow data (e.g., pressure (P), temperature (T), and liquid level (L), etc.) relating to the LH2 tank 206 (depicted as P₂, T₂, L₂ in FIG. 2).

The GH2 tank bank 205 stores a first portion of hydrogen fuel in a gaseous phase and the LH2 tank 206 stores a second portion of hydrogen fuel in a liquid phase. The GH2 tank bank 205 can be configured to store the first portion of hydrogen fuel at an increased pressure to reduce a necessary size of the GH2 tank bank 205 within an aircraft. For example, the GH2 tank bank 205 can be configured to store the first portion of hydrogen fuel at a pressure from about 100 bar up to about 1,000 bar. The GH2 tank bank 205 can be configured to store the first portion of the hydrogen fuel at a temperature within about 50° C. of an ambient temperature, or between about −50° C. and about 100° C. In some examples, the GH2 tank bank 205 can be configured as a plurality of GH2 tank bank 205 to reduce an overall size and weight that would otherwise be needed to contain the desired volume of the first portion of hydrogen fuel in the gaseous phase at the desired pressures. Gaseous hydrogen delivery can also include an example three-way boil-off valve 213 defining an example first input 216, an example second input 218, and an example output 220.

In the example of FIG. 2, the first input 216 is in fluid communication with the GH2 tank bank 205 for receiving a flow of the first portion of hydrogen fuel in the gaseous phase from the GH2 tank bank 205. The second input 218 is in fluid communication with an example boil-off fuel assembly 250 for receiving a flow of gaseous hydrogen fuel from an example first GH2 buffer tank 254 of the boil-off fuel assembly 250. The three-way boil-off valve 213 can be configured to combine and/or alternate the flows from the first input 216 and the second input 218 to a single flow of gaseous hydrogen through the output 220. For example, the three-way boil-off valve 213 can be an active valve, such that an amount of gaseous hydrogen fuel provided from the first input 216, as compared to the amount of gaseous hydrogen fuel provided from the second input 218, to the output 220 can be actively controlled. In the illustrated example of FIG. 2, an example seventh sensor 280 is configured to sense data (e.g., pressure (P), temperature (T), etc.) relating to the first GH2 buffer tank 254 (depicted as P₇, T₇ in FIG. 2).

The example first fuel distribution system 200 includes a gaseous hydrogen delivery assembly (GHDA) flow regulator 226. The GHDA flow regulator 226 can be configured as an actively controlled variable throughput valve configured to provide a variable throughput ranging from 0% (e.g., a completely closed off position) to 100% (e.g., a completely open position), as well as a number of intermediate throughput values therebetween. In FIG. 2, the GHDA flow regulator 226 includes one or more variable flow valves to provide the variable throughput therethrough. In the illustrated example of FIG. 2, a third sensor 228 measures flow data (e.g., pressure (P), temperature (T), etc.) downstream of the GHDA flow regulator 226 (depicted as P₃, T₃ in FIG. 2).

In the example of FIG. 2, the example first fuel distribution system 200 includes a three-way regulator valve 240. The three-way regulator valve 240 defines an example first input 242, an example second input 244, and an example output 247. The first input 242 is in fluid communication with the gaseous hydrogen delivery assembly 204 for receiving a flow of the first portion of hydrogen fuel in the gaseous phase from the GH2 tank bank 205. The second input 244 is in fluid communication with the liquid hydrogen delivery assembly 202 for receiving a flow of the second portion of the hydrogen fuel in the gaseous phase from the LH2 tank 206. The three-way regulator valve 240 may be configured to combine and/or alternate the flows from the first input 242 and the second input 244 to a single flow of gaseous hydrogen through the output 247. In the illustrated example of FIG. 2, the three-way regulator valve 240 is an active three-way regulator valve, including an actuator, such that an amount of hydrogen fuel provided from the first input 242, as compared to the amount of hydrogen fuel provided from the second input 244, to the output 247 may be actively controlled.

In the example of FIG. 2, the second input 244 of the three-way regulator valve 240 receives hydrogen fuel originating from a liquid hydrogen delivery assembly 202 which includes the LH2 tank 206, an example pump 246, and an example heat exchanger 248 downstream of the pump 246. In some examples, the LH2 tank 206 can define a fixed volume, such that as the LH2 tank 206 provides hydrogen fuel to the first fuel distribution system 200 substantially completely in the liquid phase, a volume of the liquid hydrogen fuel in the LH2 tank 206 decreases, and the volume is made up by, e.g., gaseous hydrogen fuel. During the normal course of storing a portion of hydrogen fuel in the liquid phase, an amount of the hydrogen fuel can vaporize (referred to herein as “boil-off.”)

To prevent an internal pressure within the LH2 tank 206 from exceeding a pressure threshold, the first fuel distribution system 200 of FIG. 2 allows for a purging of gaseous hydrogen fuel from the LH2 tank 206. For example, the first fuel distribution system 200 includes a boil-off fuel assembly 250 configured to receive gaseous hydrogen fuel from the LH2 tank 206. The boil-off fuel assembly 250 generally includes an example vent valve 251, an example boil-off compressor 252, and an example first GH2 buffer tank 254. The first GH2 buffer tank 254 is in fluid communication with the LH2 tank 206 and is further in fluid communication with the gaseous hydrogen delivery assembly 204. During operation, gaseous fuel from the LH2 tank 206 can be vented from the LH2 tank 206 by the vent valve 251, compressed by the boil-off compressor 252, and provided to the first GH2 buffer tank 254. The first GH2 buffer tank 254 stores the gaseous hydrogen fuel at a lower pressure than the pressure of the hydrogen fuel within the GH2 tank bank 205. For example, the first GH2 buffer tank 254 can be configured to maintain gaseous hydrogen fuel therein at a pressure of between about 100 bar and about 400 bar. The pressurization of the gaseous hydrogen fuel in the first GH2 buffer tank 254 can be provided substantially completely by the boil-off compressor 252. Maintaining the gaseous hydrogen fuel in the first GH2 buffer tank 254 at the lower pressure can allow for the boil-off compressor 252 to be relatively small.

The LH2 tank 206 can be connected to an example vacuum jacketed (VJ) flowline(s) 256, which is in connection with the pump 246. In some examples, the VJ flowline(s) 256 can include a flow control valve. The pump 246 is configured to provide a flow of hydrogen fuel in the liquid phase from the LH2 tank 206 through the liquid hydrogen delivery assembly 202. Operation of the pump 246 can be modulated (e.g., increased, decreased, etc.) to effectuate a change in a volume of the hydrogen fuel through the liquid hydrogen delivery assembly 202 and to an example regulator assembly 257 and the engine 209. The pump 246 can be any suitable pump configured to provide a flow of liquid hydrogen fuel. In some examples, the pump 246 is a cryogenic pump. In some examples, the pump 246 is the primary pump for the liquid hydrogen delivery assembly 202 (e.g., provides a majority of a motive force available for providing a flow of liquid hydrogen through the liquid hydrogen delivery assembly 202, etc.). In some examples, at least about 75% of the motive force available for providing a flow of liquid hydrogen through the liquid hydrogen delivery assembly 202 can be provided by the pump 246. The pump 246 can generally define a maximum pump capacity and a minimum pump capacity (each in kilograms per second). A ratio of the maximum pump capacity to the minimum pump capacity may be referred to as a turndown ratio of the pump 246. In some examples, the pump 246 can define a turndown ratio of at least 1:1 and up to about 6:1. In the example of FIG. 2, an example motor 258 can be used to power the pump 246.

The heat exchanger 248 is located downstream of the pump 246 and a flow control valve (not illustrated) and is configured to convert a portion of the hydrogen fuel through the liquid hydrogen delivery assembly 202 from the liquid phase to a gaseous phase. In the illustrated example of FIG. 2, an example fourth sensor 260 is configured to sense flow data (e.g., pressure (P), temperature (T), etc.) downstream of the pump 246 and upstream of the heat exchanger 248 (depicted as P₄, T₄ in FIG. 2). In some examples, the heat exchanger 248 can be in thermal communication with the engine 209, and more specifically, with an accessory system of the engine 209 to provide heat to increase a temperature of the hydrogen fuel through the liquid hydrogen delivery assembly 202 to increase the temperature of the GH2 to a desired level.

In the example of FIG. 2, the regulator assembly 257 further includes an example first buffer tank 262, an example flowmeter 264, and an example regulator 266. The second GH2 buffer tank 262 is configured to vary a mass flow rate of the hydrogen fuel from a fluid inlet to a fluid outlet during at least certain operations. In some examples, the second GH2 buffer tank 262 can be configured to purge gaseous hydrogen fuel through a vent valve 274 when an internal pressure of the second GH2 buffer tank 262 (e.g., a pressure within an internal cavity) exceeds an upper threshold. For example, the second GH2 buffer tank 262 can accept hydrogen fuel (e.g., at a fluid inlet) at a greater flow rate than provided by the second GH2 buffer tank 262 (e.g., at a fluid outlet) even when an internal pressure of the second GH2 buffer tank 262 is at or exceeds an upper bound or upper threshold for the second GH2 buffer tank 262 (e.g., more rapidly reduce a mass flowrate of hydrogen fuel to the combustor 210 of the engine 209, etc.). By virtue of its position within the regulator assembly 257, the second GH2 buffer tank 262 is in fluid communication with the liquid hydrogen delivery assembly 202 and/or the gaseous hydrogen delivery assembly 204. As such, the second GH2 buffer tank 262 can be configured to receive hydrogen fuel from the liquid hydrogen delivery assembly 202 and/or the gaseous hydrogen delivery assembly 204. An example fifth sensor 267 measures properties of the hydrogen in the second GH2 buffer tank 262 (depicted as P₅, T₅ in FIG. 2).

The flowmeter 264 of the regulator assembly 257 can sense data indicative of a mass flow rate of hydrogen fuel through the regulator assembly 257. For example, the flowmeter 264 can sense data indicative of one or more of a temperature of the gaseous hydrogen fuel flowing therethrough and a pressure of the gaseous hydrogen fuel flowing therethrough. In some examples, data from the flowmeter 264 can be utilized to control the regulator 266 to ensure a desired amount of fuel is provided to the combustor 210 of the engine 209. The regulator 266 can be configured as an actively controlled variable throughput valve configured to provide a variable throughput ranging from 0% (e.g., a completely closed off position) to 100% (e.g., a completely open position), as well as a number of intermediate throughput values therebetween. In some examples, the regulator 266 is in connection with the combustor 210 of the engine 209 via a flow control valve (not illustrated). In the illustrated example of FIG. 2, an example sixth sensor 268 measures flow data (e.g., pressure (P), temperature (T), etc.) into the combustor 210 (depicted as P₆, T₆ in FIG. 2).

FIG. 3 illustrates an example second fuel distribution system 300 using an example cryogenic compressed hydrogen (CCH2) tank 302 with an example thermo-syphoning loop 304 to deliver hydrogen to the example engine 209 of FIG. 2. In the illustrated example of FIG. 3, the example second fuel distribution system 300 includes the regulator assembly 257 of FIG. 2, which includes the example first buffer tank 262 of FIG. 2, the example flowmeter 264 of FIG. 2, and the example regulator 266 of FIG. 2. In the example of FIG. 3, the CCH2 tank 302 fuels an example engine 209 of an aeronautical vehicle, where the engine can be an aeronautical gas turbine engine (e.g., the gas turbine engine 106 of FIG. 1, etc.). In other examples, the second fuel distribution system 300 can be any other suitable land or aeronautical vehicle and the engine may be any other suitable engine mounted to or within the vehicle in any suitable manner. In the illustrated example of FIG. 3, the second fuel distribution system 300 delivers fuel to an example combustor 210.

The CCH2 tank 302 stores hydrogen at cryogenic temperatures (between 40 and 100 K) and relatively high pressures. The CCH2 tank 302 includes an insulated outer shell that permits hydrogen to be held cryogenic temperatures, thereby increasing the volume of hydrogen that can be stored in the tank 302. Additionally, the CCH2 tank 302 holds hydrogen at a comparatively higher pressure than the LH2 tank 206 of FIG. 2, increasing the comparatively thickness of the walls of the tank 302. In some examples, the hydrogen in the tank 302 is stored in as GH2. In other examples, the hydrogen can be any suitable mixture of GH2 and LH2. In the example of FIG. 3, the thermo-syphoning loop 304 includes an example automatic valve 306 and a first example heat exchanger 308. In the illustrated example of FIG. 304, the automatic valve 306 releases (e.g., bleeds, etc.) portions of the hydrogen of the tank 302 for warming via the heat exchanger 308. In the illustrated example of FIG. 3, the function of the heat exchanger 308 ensures that the hydrogen of the tank 302 remains at an appropriate temperature and pressure. Additionally or alternatively, the properties of the tank 302 can be regulated by a heater and/or by regulating the insulation of the tank 302. In some such examples, the thermo-syphoning loop 304 can be absent.

In the illustrated example of FIG. 3, the hydrogen flows from the CCH2 tank 302 to an example heat exchanger 309, which regulates the temperature of the flow leaving the CCH2 tank 302. In the illustrated example of FIG. 3, an example first sensor 310 measures flow data (e.g., pressure (P), temperature (T), etc.) leaving the CCH2 tank 302 (depicted as P₁, T₁ in FIG. 3) and an example second sensor 312 measures flow data (e.g., pressure (P), temperature (T), etc.) leaving the heat exchanger 309 (depicted as P₂, T₂ in FIG. 3).

In the example of FIG. 3, the example second fuel distribution system 300 includes an example three-way automatic valve 314. The three-way automatic valve 314 defines an example input 316, an example first output 318, and an example second output 320. The input 316 is in fluid communication with the heat exchanger 309 for receiving a flow of hydrogen fuel in the gaseous phase from the CCH2 tank 302. The first output 318 flow to an example regulator 322, whose output is measured by an example third sensor 324. The third sensor 324 measures flow data (e.g., pressure (P), temperature (T), etc.) from the regulator 322 (depicted as P₃, T₃ in FIG. 3). The second output 320 is fluidly coupled to an example compressor 326, whose output is measured by an example fourth sensor 328. The fourth sensor 328 measures flow data (e.g., pressure (P), temperature (T), etc.) from the compressor 326 (depicted as P₄, T₄ in FIG. 3). The second output 320 is in fluid communication with a compressor 326.

The three-way automatic valve 314 can be an active valve, such that an amount of gaseous hydrogen fuel provided to the first output 318, as compared to the amount of gaseous hydrogen fuel provided from the second output 320, from the input 316, can be actively controlled. In some examples, the three-way automatic valve 314 can be a passive valve. In the example of FIG. 3, output from the three-way automatic valve 314 travels to the regulator assembly 257 (e.g., which includes the second GH2 buffer tank 262, the flowmeter 264, and the regulator 266, etc.) prior to reaching the combustor 210. Like the sixth sensor 268 of FIG. 2, the example fifth sensor 330 measures flow data (e.g., pressure (P), temperature (T), etc.) into the combustor 210 (depicted as P₃, T₃ in FIG. 3).

FIG. 4 is a block diagram of the example fuel distribution controller circuitry 108 of FIG. 1 that may be incorporated into a fuel system developed in accordance with teachings of this disclosure. In the example of FIG. 4, the fuel distribution controller circuitry 108 includes an example sensor interface circuitry 402, an example mass flow determiner circuitry 404, an example mass loss determiner circuitry 406, an example threshold comparator circuitry 408, an example fuel distribution system interface circuitry 410, an example notification generator circuitry 412, and example data storage 414. The example fuel distribution controller circuitry 108 can be used in conjunction with the first fuel distribution system 200 of FIG. 2 and/or the second fuel distribution system 300 of FIG. 3.

The sensor interface circuitry 402 receives sensor data from the sensors of the fuel distribution system. For example, the sensor interface circuitry 402 can receive sensor data from the sensors 212, 214, 228, 260, 267, 268, 280 of the first fuel distribution system 200 of FIG. 2. For example, the sensor interface circuitry 402 can receive sensor data from the sensors 310, 312, 328, 330 of the second fuel distribution system 300 of FIG. 3. In some examples, the sensor interface circuitry 402 can transform the received sensor data from a machine-readable format (e.g., a voltage, a current, etc.) to a human-readable format (e.g., a string, a floating-point number, an integer, etc.).

The mass flow determiner circuitry 404 determines the mass flow of hydrogen through the fuel distribution system via the accessed sensor data. For example, the mass flow determiner circuitry 404 can determine the mass flow from the GH2 tank bank 205 using data from the first sensor 212 to determine the density of the H2 in tank as a function of temperature and pressure:

ρ₁(t)=f(P₁(t),T₁(t)) (1)

m₁(t)=ρ₁(t)V_{TANKBANK} (2)

wherein ρ₁ is the density of the gaseous hydrogen of the GH2 tank bank 205, t is time, P₁ is the pressure for the hydrogen as measured by the first sensor 212, T₁ is the temperature of the hydrogen of the GH2 tank bank 205 as measured by the first sensor 212, m₁(t) is the mass of the GH2 tank bank 205 as a function of time (e.g., the mass flow from the GH2 tank bank 205 into the first fuel distribution system 200, etc.), and V_{TANKBANK} is the total volume of the GH2 tank bank 205. Accordingly, using temperature and pressure sensor data from the first sensor 212 and the equations (1) and (2), the mass flow determiner circuitry 404 can determine the mass flow from the GH2 tank bank 205. In some examples, the density of the tank bank can be the average density of the hydrogen across the different tanks of the GH2 tank bank 205. In such examples, the density can be determined using sensors associated with the total outflow of the GH2 tank bank 205. Additionally or alternatively, the density and mass flow from the GH2 tank bank 205 can be determined on a per tank basis, using flow sensors associated with each tank.

The mass flow determiner circuitry 404 can determine the mass flow from the LH2 tank 206 of FIG. 2 using sensor data from the second sensor 214. For example, the mass flow determiner circuitry 404 can determine the mass flow from the LH2 tank 206 using data from the second sensor 214 to determine the density of the H2 in tank as a function of temperature and liquid level in the LH2 tank 206:

ρ_{2L}(t)=f(T₂(t)) (3)

ρ_{2V}(t)=f(T₂(t)) (4)

m₂(t)=ρ_{2L}(t)V_{LH2TANK}L₂(t)+ρ_{2V}(t)V_{LH2TANK}(1−L₂(t)) (5)

wherein ρ_{2L} is the density of the liquid hydrogen of the LH2 tank 206, ρ_{2V} is the density of the vaporous hydrogen of the LH2 tank 206, T₂ is the temperature of the hydrogen of the LH2 tank 206 as measured by the second sensor 214, m₂(t) is the mass of the LH2 tank 206 as a function of time (e.g., the mass flow from the LH2 tank 206 into the first fuel distribution system 200, etc.), V_{LH2TANK} is the volume of the LH2 tank 206, and L₂(t) is the liquid level of the LH2 tank 206. Accordingly, using temperature and liquid level sensor data from the second sensor 214 and the equations (3), (4) and (5), the mass flow determiner circuitry 404 can determine the mass flow from the LH2 tank 206. In some examples, the T₂ can be assumed to be the saturation temperature of hydrogen.

The mass flow determiner circuitry 404 can determine the mass flow from the CCH2 tank 302 of FIG. 3 using sensor data from the first sensor 310. For example, the mass flow determiner circuitry 404 can determine the mass flow from the CCH2 tank 302 using data from the second sensor 214 to determine the density of the H2 in tank as a function of temperature, pressure, and volume of the CCH2 tank 302:

$${ρ}_{1} ( t ) = f ( {P}_{1} ( t ) , {T}_{1} ( t ) ) \qquad ( 6 )$$

$${m}_{1} ( t ) = {ρ}_{1} ( t ) V \qquad ( 7 )$$

$$\dot{m} ( {t}_{12} ) = \frac{{m}_{1} ( {t}_{1} ) - {m}_{1} ( {t}_{2} )}{{t}_{2} - {t}_{1}} \qquad ( 8 )$$

wherein ρ₁(t) is the density of the hydrogen in the CCH2 tank 302 as a function of time, P₁(t) is the pressure of the hydrogen in the CCH2 tank 302 as a function of time as provided by the first sensor 310, T₁(t) is the temperature of the hydrogen in the CCH2 tank 302 as a function of time as provided by the first sensor 310, m₁(t) is the mass of the hydrogen in the CCH2 tank 302 as a function of time, V is the volume of the CCH2 tank 302, t₁ is a first time, t₂ is a second time, m₁(t₁) is the mass of hydrogen in the CCH2 tank 302 at the first time, m₂(t₂) is the mass of hydrogen in the CCH2 tank 302 at the second time, and \dot{m}(t₁₂) is the average mass flow rate of hydrogen out of the CCH2 tank 302 between the first time and the second time. In other examples, the mass flow determiner circuitry 404 can determine the mass flow rate out of the CCH2 as a function of time by any other suitable means (e.g., a flowmeter, etc.).

In some examples, the mass loss determiner circuitry 406 can determine the flow of hydrogen into the combustor 210 (e.g., in the first fuel distribution system 200 of FIG. 2, in the second fuel distribution system 300 of FIG. 3, etc.) based on sensor data received from the flowmeter 264. In some examples, the mass flow determiner circuitry 404 can determine if a vent valve of the fuel distribution system is open (e.g., the vent valve 274 associated with the first fuel distribution system 200 of FIG. 2, the vent valve 331 associated with the second fuel distribution system 300 of FIG. 3, etc.), which permits the venting of vaporous H2 from the fuel distribution system (e.g., based on sensor data from the sensor interface circuitry 402, based on a user input, etc.). The mass flow determiner circuitry 404 can determine the mass vented from the second GH2 buffer tank 262 using the properties of the vent valve 274, the pressure of the second GH2 buffer tank 262, and the duration of the valve remains open. The mass flow determiner circuitry 404 can determine the mass of vented hydrogen using pressure data of the second GH2 buffer tank 262 from data obtained from the fifth sensor 267:

$${m}_{vent} ( {t}_{2} ) = {m}_{vent} ( {t}_{1} ) + {\int }_{{t}_{1}}^{{t}_{2}} \dot{m} dt = {\int }_{{t}_{1}}^{{t}_{2}} {k}_{D} A \sqrt{{ρ}_{3} ( {P}_{3} - {P}_{a m b} ) {k ( \frac{2}{k + 1} )}^{\frac{k + 1}{k}}} dt , \qquad ( 9 )$$

wherein t₁ is a first time when a vent valve 274 is opened, t₂ is a second time when a vent valve 274 is closed, mᵥₑₙₜ is mass of hydrogen vented through the vent valve 274, \dot{m} is exhaust rate of hydrogen as a function of time, k_{D} is a discharge coefficient of the nozzle associated with the vent valve 274 (e.g., ˜0.595, etc.), A is the area of the orifice of the vent valve 274, ρ₃ is the density of hydrogen in the second GH2 buffer tank 262 (e.g., can be determined based on the pressure and temperature of the hydrogen in the second GH2 buffer tank 262, etc.), P₃ is the pressure in the second GH2 buffer tank 262, P_{amb} is the ambient pressure, and k is 1.41, the specific heat capacity ratio of H2. In some examples, the mass flow exhausted via the vent valve 331 of FIG. 3 can also be determined via Equation (9). In other examples, the mass flow exhausted via the vent valve 331 of FIG. 3 can be determined by any suitable means.

The mass loss determiner circuitry 406 determines the mass loss from the fuel distribution systems 200, 300. For example, the mass loss determiner circuitry 406 can compare the mass inflows (e.g., from the LH2 tank 206, from the GH2 tank bank 205, etc.) and mass outflows (e.g., into the combustor 210, vented from the second GH2 buffer tank 262, etc.). For example, the mass loss determiner circuitry 406 can determine the mass balance of the first fuel distribution system 200 of FIG. 2 based on comparing the hydrogen flow from the LH2 tank 206 and the GH2 tank bank 205 and the hydrogen exhausted via the vent valve 274 and into the combustor 210:

∫ₜ_{₁}^{t}^{₂}\dot{m}_{flow}dt=m₂(t₁)−m₂(t₂)+m₁(t₁)−m₁(t₂)+m₅(t₁)−m₅(t₁)−m₅(t₂)+m₇(t₁)−m₇(t₂)−mᵥₑₙₜ(t₂)+mᵥₑₙₜ(t₁) (10)

ML(t₂)=m₂(t₁)−m₂(t₂)+m₁(t₁)−m₁(t₂)+m₅(t₁)−m₅(t₂)+m₇(t₁)−m₇(t₂)−mᵥₑₙₜ(t₂)+mᵥₑₙₜ(t₁)−∫ₜ_{₁}^{t}^{₂}\dot{m}_{flow}dt (10)

wherein \dot{m}_{flow} is the mass flow rate out of the first fuel distribution system 200 (as measured by the flowmeter 264 and/or sixth sensor 268), m₁(t₁) is the mass of hydrogen associated with the GH2 tank bank 205 at the first time, m₁(t₂) is the mass of hydrogen associated with the GH2 tank bank 205 at the second time, m₂(t₁) is the mass of hydrogen associated with the LH2 tank 206 at the first time, m₂(t₂) is the mass of hydrogen associated with the LH2 tank 206 at the second time, m₅(t₁) is the mass of hydrogen associated with the first GH2 buffer tank 254 at the first time, m₅(t₂) is the mass of hydrogen associated with the first GH2 buffer tank 254 at the second time, m₇(t₁) is the mass of hydrogen associated with the second GH2 buffer tank 262 at the first time, m₇(t₂) is the mass of hydrogen associated with the second GH2 buffer tank 262 at the second time, mᵥₑₙₜ(t₂) is the mass of hydrogen vented through the vent valve 274 at the second time, mᵥₑₙₜ(t₁) is mass of hydrogen vented through the vent valve 274 at the first time, and ML(t₂) is the cumulative mass loss between the first time and the second time.

The mass loss determiner circuitry 406 can determine the mass balance of the second fuel distribution system 300 of FIG. 3 based on comparing the hydrogen flow from the CCH2 tank 302 and the hydrogen exhausted via the vent valve 274 and into the combustor 210:

∫ₜ_{₁}^{t}^{₂}\dot{m}_{flow}dt=m₁(t₁)−m₁(t₂)+m₄(t₁)−m₄(t₂)−mᵥₑₙₜ(t₂)+mᵥₑₙₜ(t₁) (12)

ML(t₂)=m₁(t₁)−(m₁(t₂)+m₄(t₁)−m₄(t₂)−mᵥₑₙₜ(t₂)+mᵥₑₙₜ(t₁)−∫ₜ_{₁}^{t}^{₂}\dot{m}_{flow}dt (13)

wherein \dot{m}_{flow} is the mass flow rate out of the second fuel distribution system 300 (as measured by the flowmeter 264 and/or the fifth sensor 330), m₁(t₁) is the mass of the hydrogen in the CCH2 tank 302 at the first time, m₁(t₂) is the mass of the hydrogen in the CCH2 tank 302 at the second time, m₄(t₁) is the mass of hydrogen associated with the fifth sensor 330 at the first time, mᵥₑₙₜ(t₂) is the mass of hydrogen vented through the vent valve 274 at the second time, mᵥₑₙₜ(t₁) is mass of hydrogen vented through the vent valve 274 at the first time, ML(t₂) is the cumulative mass loss of the second fuel distribution system 300 between the first time and the second time, and m₄(t₂) is the mass of hydrogen associated with the fifth sensor 330 at the second time. As such, the mass loss determiner circuitry 406 can determine the mass loss rate associated with the first fuel distribution system 200 of FIG. 2 and/or the second fuel distribution system 300 of FIG. 3.

The threshold comparator circuitry 408 compares the determined mass loss rate to one or more thresholds. For example, the threshold comparator circuitry 408 can determine if the determined mass loss rate satisfies (e.g., exceeds, etc.) a first threshold (e.g., a warning threshold, etc.). Additionally or alternatively, the threshold comparator circuitry 408 can determine if the determined mass loss rate satisfies (e.g., is less than, etc.) a second threshold (e.g., a recalibration threshold, etc.). In some examples, the first threshold and the second threshold can be the same (e.g., zero, etc.). In such examples, when the mass loss rate is greater than the single threshold, the threshold comparator circuitry 408 can trigger actions (e.g., issuing a warning, isolating the leak, etc.) associated with satisfying the first threshold and when the mass loss rate is less than the single threshold, the threshold comparator circuitry 408 can trigger actions associated with satisfying the second threshold (e.g., generating a notification to recalibrate the sensors, etc.).

The fuel distribution system interface circuitry 410 interfaces with the first fuel distribution system 200 and/or the second fuel distribution system 300. For example, if the threshold comparator circuitry 408 determines the mass loss rate satisfies the first threshold, the fuel distribution system interface circuitry 410 can, via the sensor data, determine where in the fuel distribution system (e.g., the first fuel distribution system 200 and/or the second fuel distribution system 300, etc.). In some examples, the fuel distribution system interface circuitry 410 can present to a user of the fuel distribution system (e.g., an operator of the aircraft 100, etc.) an indication of where the detected leak is. Additionally or alternatively, the fuel distribution system interface circuitry 410 can isolate the detected leak by closing a valve, closing a regulator, routing hydrogen through an alternative part of the fuel distribution system, etc.

The notification generator circuitry 412 generates an example notification for a user (e.g., a pilot, a technician, an operator, etc.) of the fuel distribution system (e.g., the first fuel distribution system 200, the second fuel distribution system 300, etc.). For example, the notification generator circuitry 412 can generate an audio notification (e.g., an alarm, an audio alert, a verbal alert, etc.), a visual notification (e.g., a dash indicator, a graphic, a text warning, etc.), a tactical notification, and/or any other suitable type of notification. For example, if the threshold comparator circuitry 408 determines that the mass loss rate satisfies the first threshold, the notification generator circuitry 412 can alert a user of the fuel distribution system that a leak may be occurring. For example, if the threshold comparator circuitry 408 determines that the mass loss rate satisfies the second threshold, the notification generator circuitry 412 alerting a user of the sensors of the fuel distribution system may need to be recalibrated.

The data storage 414 can be used to store any information associated the sensor interface circuitry 402, the mass flow determiner circuitry 404, the mass loss determiner circuitry 406, the threshold comparator circuitry 408, the fuel distribution system interface circuitry 410, and/or the notification generator circuitry 412. The example data storage 414 of the illustrated example of FIG. 4 can be implemented by any memory, storage device and/or storage disc for storing data such as flash memory, magnetic media, optical media, etc. Furthermore, the data stored in the example data storage 414 can be in any data format such as binary data, comma delimited data, tab delimited data, structured query language (SQL) structures, image data, etc.

While an example manner of implementing the fuel distribution controller circuitry 108 of FIG. 1 is illustrated in FIG. 4, one or more of the elements, processes, and/or devices illustrated in FIG. 4 may be combined, divided, re-arranged, omitted, eliminated, and/or implemented in any other way. Further, the example sensor interface circuitry 402, the example mass flow determiner circuitry 404, the example mass loss determiner circuitry 406, the example threshold comparator circuitry 408, the example fuel distribution system interface circuitry 410, the example notification generator circuitry 412, and/or, more generally, the example the fuel distribution controller circuitry 108 of FIG. 1, may be implemented by hardware alone or by hardware in combination with software and/or firmware. Thus, for example, any of the example sensor interface circuitry 402, the example mass flow determiner circuitry 404, the example mass loss determiner circuitry 406, the example threshold comparator circuitry 408, the example fuel distribution system interface circuitry 410, the example notification generator circuitry 412, and/or, more generally, the example fuel distribution controller circuitry 108, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example fuel distribution controller circuitry 108 of FIG. 1 may include one or more elements, processes, and/or devices in addition to, or instead of, those illustrated in FIG. 4, and/or may include more than one of any or all of the illustrated elements, processes and devices.

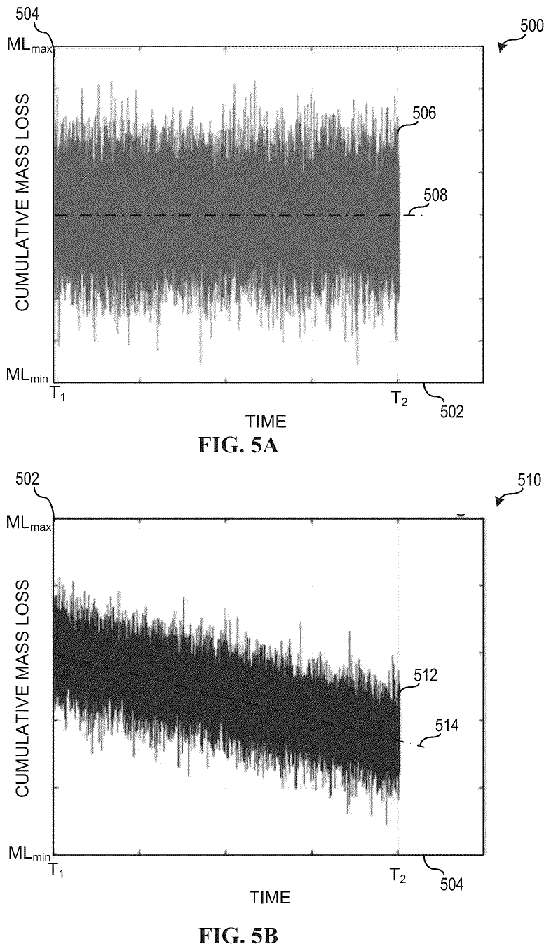

FIG. 5A illustrates an example first diagram 500 depicting the average mass loss of a fuel distribution system (e.g., the first fuel distribution system 200 of FIG. 2, the second fuel distribution system 300 of FIG. 3, etc.). In the illustrated example of FIG. 5A, the first diagram 500 includes an x-axis 502 corresponding to time and a y-axis 504 corresponding to an amount of cumulative fuel loss in the fuel distribution system. The first diagram 500 illustrates an example first relationship curve 506 having an example first trend line 508.

The x-axis 502 measures the independent variable time, which begins at T₁, and ends at T₂. In some examples, an elapsed time between T₁ and T₂ is a period over which an average mass loss and/or cumulative mass loss is determined. The x-axis can be measured in any suitable unit (e.g., seconds, minutes, etc.). The y-axis 504 measures the cumulative mass loss, which ranges from MLₘᵢₙ and MLₘₐₓ which are selected to ensure the first relationship curve 506 is visible in the first diagram 500.

The first relationship curve 506 represents an instantaneous mass loss at a particular time determined via a mass balancing analysis conducted by the mass loss determiner circuitry 406 of FIG. 4. In the illustrated example of FIG. 5A, the instantaneous values of the first relationship curve 506 vary over the period between T₁ and T₂ due to noise in the sensor data (e.g., from the sensors 212, 214, 228, 260, 267, 268, etc.) caused by sensor errors and/or inaccuracy. As such, the average mass and/or the cumulative mass loss can be determined over the period, which is represented by the first trend line 508. In the illustrated example of FIG. 5A, the first trend line 508 is zero. As such, the fuel distribution controller circuitry 108 (e.g., by comparing the determined loss to the first threshold and the second threshold, etc.) can determine that the fuel distribution system (e.g., the first fuel distribution system 200, the second fuel distribution system 300, etc.) does not include a leak and/or require sensor recalibration.

FIG. 5B illustrates an example second diagram 510 depicting an average mass loss of a fuel distribution system (e.g., the first fuel distribution system 200 of FIG. 2, the second fuel distribution system 300 of FIG. 3, etc.). In the illustrated example of FIG. 5B, the second diagram 510 includes the x-axis 502, the time, and the y-axis 504, corresponding to an amount of cumulative fuel loss in the fuel distribution system. The example second diagram 510 illustrates an example second relationship curve 512 having an example second trend line 514.

The second relationship curve 512 represents the instantaneous mass loss at a particular period of time determined via a mass balancing analysis conducted by the mass loss determiner circuitry 406 of FIG. 4. Like the first relationship curve 506, the instantaneous value of the second relationship curve 512 varies due to the received sensor data (e.g., from the sensors 212, 214, 228, 260, 267, 268, etc.) caused by sensor errors and/or inaccuracies. As such, the average mass and/or the cumulative mass loss can be determined over a time period, which is represented by the second trend line 514. In the illustrated example of FIG. 5B, the second trend line 514 has a downward slope. As such, the fuel distribution controller circuitry 108 (e.g., by comparing the determined loss to the first threshold and the second threshold, etc.) can determine that the fuel distribution system (e.g., the first fuel distribution system 200, the second fuel distribution system 300, etc.) includes a leak. In some such examples, the fuel distribution controller circuitry 108 can attempt to identify the location of the leak in the fuel distribution systems 200, 300 and attempt to isolate the leak to prevent further hydrogen leakage.

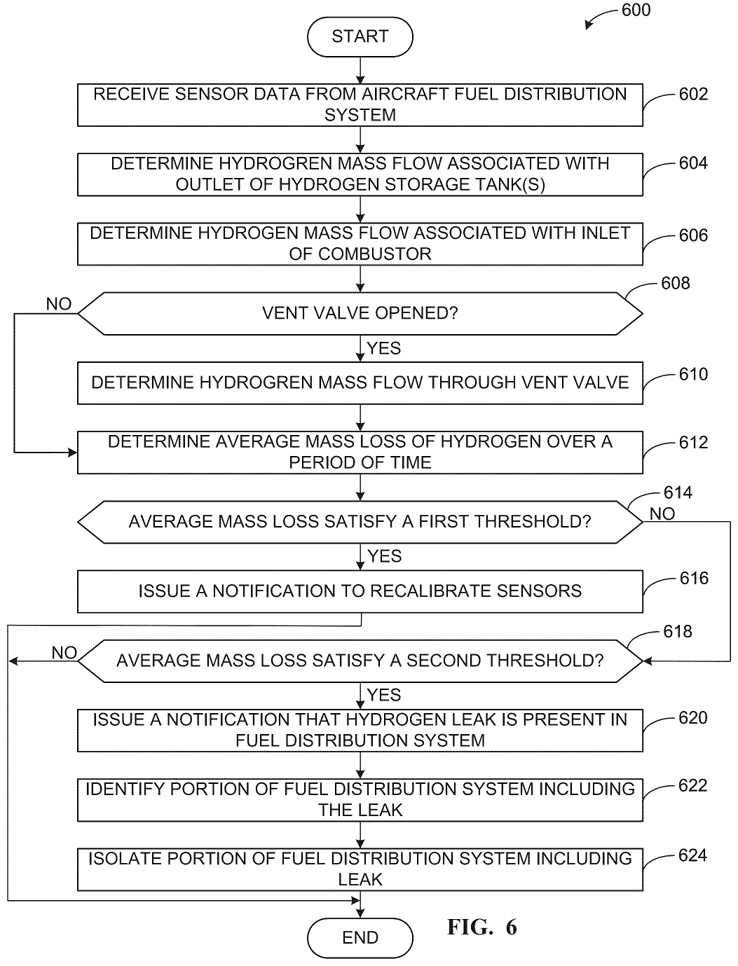

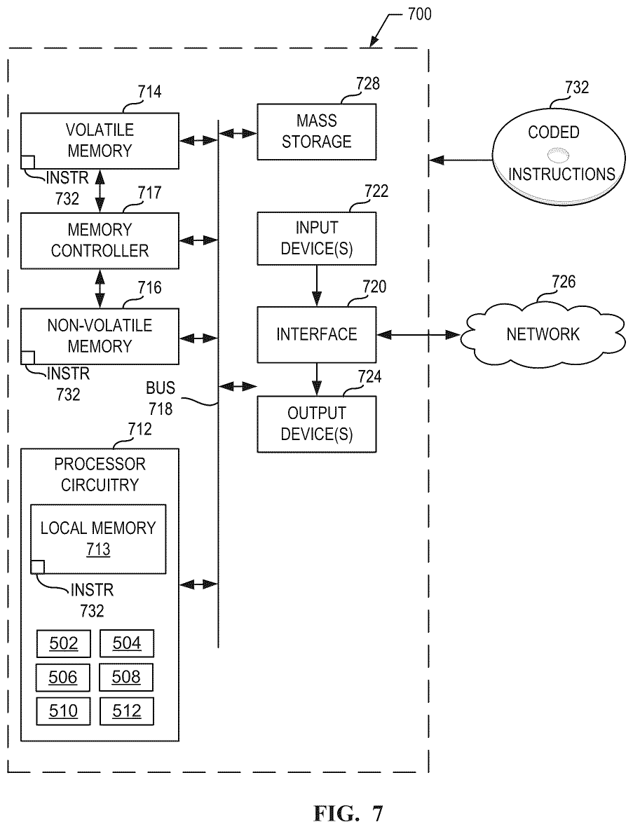

A flowchart representative of example hardware logic circuitry, machine readable instructions, hardware implemented state machines, and/or any combination thereof for implementing the fuel distribution controller circuitry 108 of FIG. 1 is shown in FIG. 6. The machine readable instructions may be one or more executable programs or portion(s) of an executable program for execution by processor circuitry, such as the processor circuitry 712 shown in the example processor platform 700 discussed below in connection with FIG. 7. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 6, many other methods of implementing the example fuel distribution controller circuitry 108 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 6 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

FIG. 6 is a flowchart representative of example machine readable instructions and/or example operations 600 that may be executed and/or instantiated by processor circuitry to identify faults in a fuel distribution system (e.g., the first fuel distribution system 200 of FIG. 2, the second fuel distribution system 300 of FIG. 3, etc.). The machine readable instructions and/or the operations 600 of FIG. 6 begin at block 602, at which the sensor interface circuitry 402 receives sensor data from the aircraft fuel distribution (e.g., the first fuel distribution system 200 of FIG. 2, the second fuel distribution system 300 of FIG. 3, etc.). For example, the sensor interface circuitry 402 can receive sensor data from the sensors 212, 214, 228, 260, 267, 268 of the first fuel distribution system 200 of FIG. 2. For example, the sensor interface circuitry 402 can receive sensor data from the sensors 310, 312, 324, 328, 330 of the second fuel distribution system 300 of FIG. 3. In some examples, the sensor interface circuitry 402 can transform the received sensor data from a machine-readable format (e.g., a voltage, a current, etc.) to a human-readable format (e.g., a string, a floating-point number, an integer, etc.).

At block 604, the mass flow determiner circuitry 404 determines hydrogen mass flow associated with outlet of the hydrogen fuel tanks. For example, when the first fuel distribution system 200 is being analyzed, the mass flow determiner circuitry 404 can determine the mass flow from the GH2 fuel tanks using Equations (1) and (2) and/or the mass flow rate from the LH2 tank 206 using the equations (3), (4), and (5). In some examples, when the second fuel distribution system 300 is being analyzed, the mass flow determiner circuitry 404 can determine the mass flow from the CCH2 tank using equations (6)-(8). In other examples, the mass flow rate determiner can determine the mass flow rate from the hydrogen sources from any suitable means.

At block 606, the mass flow determiner circuitry 404 determines the hydrogen mass flow associated with the inlet of the combustor (e.g., the combustor 210 of FIGS. 2 and 3, etc.) For example, the mass flow determiner circuitry 404 can determine the flow of hydrogen into the combustor 210 (e.g., in the first fuel distribution system 200 of FIG. 2, in the second fuel distribution system 300 of FIG. 3, etc.) based on sensor date received from the flowmeter 264. In other examples, the mass flow determiner circuitry 404 can determine the mass flow of hydrogen into the engine by any other suitable means.

At block 608, the mass flow determiner circuitry 404 determines whether the valve vent is open. For example, the mass flow determiner circuitry 404 can determine whether the valve vent is open based on a user input. In some examples, the mass flow determiner circuitry 404 can determine whether the valve vent is open based on sensor data received from the sensor interface circuitry 402 and/or any other suitable method. When the mass flow determiner circuitry 404 determines the valve vent is open, the operations 600 advance to block 610. When the mass flow determiner circuitry 404 determines the valve vent is not open, the operations 600 advance to block 612.

At block 610, the mass flow determiner circuitry 404 determines the hydrogen mass flow through the vent valve. For example, the mass flow determiner circuitry 404 can determine the mass vented from the second GH2 buffer tank 262 using the properties of the vent valve 274, the pressure of the second GH2 buffer tank 262, and the duration of the valve remains open. In some examples, the mass flow determiner circuitry 404 can determine the mass flow through the vent using equation (9). In other examples, the mass flow determiner circuitry 404 can determine the hydrogen mass flow by any other suitable method.

At block 612, the mass loss determiner circuitry 406 determines the average mass loss of hydrogen over a period of time. For example, the mass loss determiner circuitry 406 can compare the mass inflows (e.g., from the LH2 tank 206, from the GH2 tank bank 205, from the CCH2 tank 302, etc.) and mass outflows (e.g., into the combustor 210, vented from the second GH2 buffer tank 262, etc.). For example, the mass loss determiner circuitry 406 can determine the average mass loss of hydrogen of the first fuel distribution system 200 using equations (10) and (11) and the second fuel distribution system 300 using equations (12) and (13). In other examples, the mass loss determiner circuitry 406 can determine the average mass loss by any other suitable means.

At block 614, the threshold comparator circuitry 408 determines whether the average mass loss satisfies a first threshold. For example, the threshold comparator circuitry 408 can determine whether the average mass loss exceeds the first threshold (e.g., a recalibration threshold, etc.). When the threshold comparator circuitry 408 determines the mass loss satisfies the first threshold, the operations 600 advance to block 618. When the threshold comparator circuitry 408 determines the mass loss does not satisfy the first threshold, the operations 600 advance to block 620.

At block 616, the notification generator circuitry 412 issues a notification to recalibrate sensors (e.g., the sensors 212, 214, 228, 260, 267, 268 of FIG. 2, the sensors 310, 312, 324, 328, 330 of FIG. 3, etc.). For example, the notification generator circuitry 412 can generate an audio notification (e.g., an alarm, an audio alert, a verbal alert, etc.), a visual notification (e.g., a dash indicator, a graphic, a text warning, etc.), a tactical notification, and/or any other suitable type of notification to recalibrate.

At block 618, the threshold comparator circuitry 408 determines whether the average mass loss satisfies a second threshold. For example, the threshold comparator circuitry 408 can compare the determined mass loss to a second threshold (e.g., a leak notification threshold, etc.) When the threshold comparator circuitry 408 determines the mass loss satisfies the second threshold, the operations 600 advance to block 620. When the threshold comparator circuitry 408 determines the mass loss does not satisfy the first threshold, the operations 600 ends.

At block 620, the notification generator circuitry 412 issues a notification that a hydrogen leak is present in the fuel distribution system. For example, the notification generator circuitry 412 can generate an audio notification (e.g., an alarm, an audio alert, a verbal alert, etc.), a visual notification (e.g., a dash indicator, a graphic, a text warning, etc.), a tactical notification, and/or any other suitable type of notification.

At block 622, the fuel distribution system interface circuitry 410 identifies portions of the fuel distribution system including the leak. For example, when the threshold comparator circuitry 408 determines the mass loss rate satisfies the first threshold, the fuel distribution system interface circuitry 410 can, via the sensor data, determine where in the fuel distribution system (e.g., the first fuel distribution system 200 and/or the second fuel distribution system 300, etc.) the leak has occurred. For example, the location of the leak can be inferred by controlling the valve 240 of FIG. 2. In some such examples, if a leak is detected in the first fuel distribution system 200, the first input 242 (e.g., supply from the GH2 tank bank 205, etc.) can be closed. In such examples, if the leak persists, the fuel distribution system interface circuitry 410 can identify that the leak exists in the gaseous hydrogen delivery assembly 204. Similarly, if a leak persists when the second input 244 is closed, the fuel distribution system interface circuitry 410 can identify that the leak exists in the liquid hydrogen delivery assembly 202.

At block 624, the fuel distribution system interface circuitry 410 isolates the portion of the fuel distribution system including the leak. For example, the fuel distribution system interface circuitry 410 can isolate the detected leak by closing a valve, closing a regulator, disabling the combustor 210, routing hydrogen through an alternative part of the fuel distribution system, etc. In some examples, if a leak is detected in a portion of the fuel distribution system 200 that has an alternative path (e.g., back-up path, a redundant path, etc.) available, the fuel distribution system interface circuitry 410 can close the portion with the leak (e.g., via a valve, etc.) and the hydrogen fuel can be rout through the alternative. In some examples, if a leak is detected in one of the hydrogen delivery assemblies 202, 204, the fuel distribution system interface circuitry 410 can disable said delivery system (e.g., by closing a corresponding one of the inputs 242, 244, etc.) until the first fuel distribution system 200 can be serviced/repaired. The operations 600 end.

Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 7 is a block diagram of an example processor platform 700 including processor circuitry structured to execute the example machine readable instructions of FIG. 6 to implement the fuel distribution controller circuitry of FIGS. 1 and 4. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 700 of the illustrated example includes processor circuitry 712. The processor circuitry 712 of the illustrated example is hardware. For example, the processor circuitry 712 can be implemented by one or more integrated circuits, logic circuits, FPGAs microprocessors, CPUs, GPUs, DSPs, and/or microcontrollers from any desired family or manufacturer. The processor circuitry 712 may be implemented by one or more semiconductor based (e.g., silicon based) devices. In this example, the processor circuitry 712 implements the sensor interface circuitry 402, the mass flow determiner circuitry 404, the mass loss determiner circuitry 406, the threshold comparator circuitry 408, the fuel distribution system interface circuitry 410, and the notification generator circuitry 412.

The processor circuitry 712 of the illustrated example includes a local memory 713 (e.g., a cache, registers, etc.). The processor circuitry 712 of the illustrated example is in communication with a main memory including a volatile memory 714 and a non-volatile memory 716 by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717.

The processor platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 722 are connected to the interface circuitry 720. The input device(s) 722 permit(s) a user to enter data and/or commands into the processor circuitry 712. The input device(s) 722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 724 are also connected to the interface circuitry 720 of the illustrated example. The output devices 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 700 of the illustrated example also includes one or more mass storage devices 728 to store software and/or data. Examples of such mass storage devices 728 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 732, which may be implemented by the machine readable instructions of FIG. 6, may be stored in the mass storage device 728, in the volatile memory 714, in the non-volatile memory 716, and/or on a removable non-transitory computer readable storage medium such as a CD or DVD.

From the foregoing, it will be appreciated that example systems, methods, apparatus, and articles of manufacture have been disclosed that monitor the health of hydrogen fuel based distribution systems. Examples disclosed herein can identify if a leak is present in the fuel distribution system using sensor data collected over a period of time. In some such examples, the health monitoring systems disclosed herein can identify the portion of the system including the leak and isolate the section to prevent additional hydrogen leaking. Examples disclosed herein can also determine if the sensors need to be recalibrated based on detected negative mass loss, thereby ensuring the systems sensors are presenting accurate readings.

Further aspects of the present disclosure are provided by the subject matter of the following clauses:

Example 1 includes a fuel distribution system including a first hydrogen fuel tank, a first sensor associated with the first hydrogen fuel tank, a second sensor associated with a combustor, and a controller to determine a first rate of change in a first amount of hydrogen in the first hydrogen fuel tank based on a first input from the first sensor, determine a flow rate of hydrogen into the combustor based on a second input from the second sensor, and determine an average mass loss rate based on the first rate of change and the flow rate, and in response to determining the average mass loss rate satisfies a first threshold, determine a leak is present in the fuel distribution system.

Example 2 includes the fuel distribution system of any preceding clause, further including a second hydrogen fuel tank and wherein the controller is further to determine a second rate of change in a second amount of hydrogen in the second hydrogen fuel tank, and the controller further determines the average mass loss rate based on the second rate of change.

Example 3 includes the fuel distribution system of any preceding clause, wherein the first hydrogen fuel tank is a liquid hydrogen fuel tank and the second hydrogen fuel tank is a gaseous hydrogen fuel tank.

Example 4 includes the fuel distribution system of any preceding clause, wherein the first hydrogen fuel tank is a cryocompressed hydrogen fuel tank.

Example 5 includes the fuel distribution system of any preceding clause, wherein the controller is further to in response to determining the average mass loss rate satisfies a second threshold, determine at least one of the first sensor or the second sensor requires recalibration, and issue a notification to recalibrate the first sensor or the second sensor.

Example 6 includes the fuel distribution system of any preceding clause, wherein the controller is, in response to determining the average mass loss rate satisfies the first threshold, further to identify a location of the leak in the fuel distribution system, and isolate the location in the fuel distribution system.

Example 7 includes the fuel distribution system of any preceding clause, wherein the first threshold is zero.

Example 8 includes a non-transitory computer readable medium comprising instructions, which when executed cause a processor to determine a first rate of change in a first amount of hydrogen in a first hydrogen fuel tank based on a first input from a first sensor associated with the first hydrogen fuel tank, determine a flow rate of hydrogen into a combustor of a gas turbine engine based on a second input from a second sensor associated with the combustor, the combustor coupled to the first hydrogen fuel tank via a fuel distribution system, and determine an average mass loss rate based on the first rate of change and the flow rate, and in response to determining the average mass loss rate satisfies a first threshold, determine a leak is present in the fuel distribution system.

Example 9 includes the non-transitory computer readable medium of any preceding clause, wherein the instructions when executed, cause the processor to determine a second rate of change in a second amount of hydrogen in a second hydrogen fuel tank, and further determine the average mass loss rate based on the second rate of change.

Example 10 includes the non-transitory computer readable medium of any preceding clause, wherein the first hydrogen fuel tank is a liquid hydrogen fuel tank and the second hydrogen fuel tank is a gaseous hydrogen fuel tank.

Example 11 includes the non-transitory computer readable medium of any preceding clause, wherein the first hydrogen fuel tank is a cryo-compressed hydrogen fuel tank.

Example 12 includes the non-transitory computer readable medium of any preceding clause, wherein the instructions when executed, cause the processor to in response to determining the average mass loss rate satisfies a second threshold, determine at least one of the first sensor or the second sensor requires recalibration, and issue a notification to recalibrate the first sensor or the second sensor.

Example 13 includes the non-transitory computer readable medium of any preceding clause, wherein the instructions when executed, cause the processor to in response to determining the average mass loss rate satisfies the first threshold identify a location of the leak in the fuel distribution system, and isolate the location in the fuel distribution system.

Example 14 includes the non-transitory computer readable medium of any preceding clause, wherein the first threshold is zero.

Example 15 includes a method including determining a first rate of change in a first amount of hydrogen in a first hydrogen fuel tank based on a first input from a first sensor associated with the first hydrogen fuel tank, determining a flow rate of hydrogen into a combustor of a gas turbine engine based on a second input from a second sensor associated with the combustor, the combustor coupled to the first hydrogen fuel tank via a fuel distribution system, and determining an average mass loss rate based on the first rate of change and the flow rate, and in response to determining the average mass loss rate satisfies a first threshold, determining a leak is present in the fuel distribution system.

Example 16 includes the method of any preceding clause, further including determining a second rate of change in a second amount of hydrogen in a second hydrogen fuel tank, and further determining the average mass loss rate based on the second rate of change.

Example 17 includes the method of any preceding clause, wherein the first hydrogen fuel tank is a liquid hydrogen fuel tank and the second hydrogen fuel tank is a gaseous hydrogen fuel tank.

Example 18 includes the method of any preceding clause, further including in response to determining the average mass loss rate satisfies a second threshold, determining at least one of the first sensor or the second sensor requires recalibration, and issuing a notification to recalibrate the first sensor or the second sensor.

Example 19 includes the method of any preceding clause, further including, in response to determining the average mass loss rate satisfies the first threshold identifying a location of the leak in the fuel distribution system, and isolating the location in the fuel distribution system.

Example 20 includes the method of any preceding clause, wherein the first threshold is zero.

Example 21 includes the mass loss average mass loss rate is determined based on an integral of the mass flow rate of the fuel distribution system, a flow of hydrogen through a vent of the fuel distribution system, the first rate of change, the second rate of change and a third rate of change in a third amount of hydrogen in a buffer tank of the fuel distribution system.

Example 22 the mass loss average mass loss rate is determined based on an integral of the mass flow rate of the fuel distribution system, a flow of hydrogen through a vent of the fuel distribution system, the first rate of change, the second rate of change, a third rate of change in a third amount of hydrogen in a first buffer tank of the fuel distribution system, and a fourth rate of change in a fourth amount of hydrogen in a second buffer tank of the fuel distribution system.

Example 22 includes an apparatus including a first means for hydrogen storage, a first means for sensing associated with the first means for hydrogen storage, a second means for sensing associated with a combustor, a means for processing to determine a first rate of change in a first amount of hydrogen in the first means for hydrogen storage based on a first input from the first means for sensing, determine a flow rate of hydrogen into the combustor based on a second input from the second means for sensing, and determine an average mass loss rate based on the first rate of change and the flow rate, and in response to determining the average mass loss rate satisfies a first threshold, determine a leak is present in the apparatus.

Example 23 includes the apparatus of any preceding clause, further including a second means for hydrogen storage and wherein the means for processing is further to determine a second rate of change in a second amount of hydrogen in the second means for hydrogen storage, and the means for processing further determines the average mass loss rate based on the second rate of change.

Example 24 includes the apparatus of any preceding clause, wherein the first means for hydrogen storage contains liquid hydrogen and the second means for hydrogen storage contains gaseous hydrogen.

Example 25 includes the apparatus of any preceding clause, wherein the first means for hydrogen storage includes a cryo-compressed gaseous hydrogen.

Example 26 includes the apparatus of any preceding clause, wherein the means for processing is further to in response to determining the average mass loss rate satisfies a second threshold, determine at least one of the first means for sensing or the second means for sensing requires recalibration, and issue a notification to recalibrate first means for sensing or the second means for sensing.

Example 27 includes the apparatus of any preceding clause, wherein the means for processing is, in response to determining the average mass loss rate satisfies the first threshold, further to identify a location of the leak in the apparatus, and isolate the location in the apparatus.

Example 28 includes the apparatus of any preceding clause, wherein the first threshold is zero.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

1. A fuel distribution system including:
a first hydrogen fuel tank;
a first sensor associated with the first hydrogen fuel tank;
a second sensor associated with a combustor; and
a controller configured to:
determine a first rate of change in a first amount of hydrogen in the first hydrogen fuel tank based on (1) a liquid level of the first hydrogen fuel tank, (2) a volume of the first hydrogen fuel tank, (3) a first density of liquid hydrogen in the first hydrogen fuel tank, and (4) a second density of a gaseous hydrogen in the first hydrogen fuel tank, the liquid level based on a first input from the first sensor;
determine a flow rate of hydrogen into the combustor based on a second input from the second sensor;
determine an average mass loss rate based on the first rate of change and the flow rate; and
in response to determining the average mass loss rate satisfies a first threshold, determine a leak is present in the fuel distribution system.

2. The fuel distribution system of claim 1, further including a second hydrogen fuel tank and wherein the controller is further to determine a second rate of change in a second amount of hydrogen in the second hydrogen fuel tank, and the controller further configured to determine the average mass loss rate based on the second rate of change.

3. The fuel distribution system of claim 2, wherein the second hydrogen fuel tank is a gaseous hydrogen fuel tank.

4. The fuel distribution system of claim 1, wherein the first hydrogen fuel tank is a cryo-compressed hydrogen fuel tank.

5. The fuel distribution system of claim 1, wherein the controller is further configured to:
in response to determining the average mass loss rate satisfies a second threshold, determine at least one of the first sensor or the second sensor requires recalibration; and
issue a notification to recalibrate the first sensor or the second sensor.

6. The fuel distribution system of claim 1, wherein the controller is, in response to determining the average mass loss rate satisfies the first threshold, further configured to:
identify a location of the leak in the fuel distribution system; and
isolate the location in the fuel distribution system.

7. The fuel distribution system of claim 1, wherein the first threshold is zero.

8. A non-transitory computer readable medium comprising instructions, which, when executed, cause a processor to:
determine a first rate of change in a first amount of hydrogen in a first hydrogen fuel tank based on (1) a liquid level of the first hydrogen fuel tank, (2) a volume of the first hydrogen fuel tank, (3) a first density of liquid hydrogen in the first hydrogen fuel tank, and (4) a second density of a gaseous hydrogen in the first hydrogen fuel tank, the liquid level based on a first input from a first sensor associated with the first hydrogen fuel tank;
determine a flow rate of hydrogen into a combustor of a gas turbine engine based on a second input from a second sensor associated with the combustor, the combustor coupled to the first hydrogen fuel tank via a fuel distribution system;
determine an average mass loss rate based on the first rate of change and the flow rate; and
in response to determining the average mass loss rate satisfies a first threshold, determine a leak is present in the fuel distribution system.

9. The non-transitory computer readable medium of claim 8, wherein the instructions when executed, cause the processor to:
determine a second rate of change in a second amount of hydrogen in a second hydrogen fuel tank; and
further determine the average mass loss rate based on the second rate of change.

10. The non-transitory computer readable medium of claim 9, wherein the second hydrogen fuel tank is a gaseous hydrogen fuel tank.

11. The non-transitory computer readable medium of claim 8, wherein the first hydrogen fuel tank is a cryo-compressed hydrogen fuel tank.

12. The non-transitory computer readable medium of claim 8, wherein the instructions when executed, cause the processor to:
in response to determining the average mass loss rate satisfies a second threshold, determine at least one of the first sensor or the second sensor requires recalibration; and
issue a notification to recalibrate the first sensor or the second sensor.

13. The non-transitory computer readable medium of claim 8, wherein the instructions when executed, cause the processor to in response to determining the average mass loss rate satisfies the first threshold:
identify a location of the leak in the fuel distribution system; and
isolate the location in the fuel distribution system.

14. The non-transitory computer readable medium of claim 8, wherein the first threshold is zero.

15. A method including:
determining a first rate of change in a first amount of hydrogen in a first hydrogen fuel tank based on (1) a liquid level of the first hydrogen fuel tank, (2) a volume of the first hydrogen fuel tank, (3) a first density of liquid hydrogen in the first hydrogen fuel tank, and (4) a second density of a gaseous hydrogen in the first hydrogen fuel tank, the liquid level based on a first input from a first sensor associated with the first hydrogen fuel tank;
determining a flow rate of hydrogen into a combustor of a gas turbine engine based on a second input from a second sensor associated with the combustor, the combustor coupled to the first hydrogen fuel tank via a fuel distribution system;
determining an average mass loss rate based on the first rate of change and the flow rate; and
in response to determining the average mass loss rate satisfies a first threshold, determining a leak is present in the fuel distribution system.

16. The method of claim 15, further including:
determining a second rate of change in a second amount of hydrogen in a second hydrogen fuel tank; and
further determining the average mass loss rate based on the second rate of change.

17. The method of claim 16, wherein the second hydrogen fuel tank is a gaseous hydrogen fuel tank.

18. The method of claim 15, further including:
in response to determining the average mass loss rate satisfies a second threshold, determining at least one of the first sensor or the second sensor requires recalibration; and
issuing a notification to recalibrate the first sensor or the second sensor.

19. The method of claim 15, further including, in response to determining the average mass loss rate satisfies the first threshold:
identifying a location of the leak in the fuel distribution system; and
isolating the location in the fuel distribution system.

20. The method of claim 15, wherein the first threshold is zero.
